(19) United States
(12) Patent Application Publication
(10) Pub. No.: US 2025/0103575 A1
(43) Pub. Date: Mar. 27, 2025

(54) METHODS AND SYSTEMS FOR PROBABILITY TREE REDUCTION

(71) Applicant: GM Global Technology Operations LLC, Detroit, MI (US)

(72) Inventors: Ronit BUSTIN, Kfar Saba (IL); Claudia Goldman-Shenhar, Mevasseret Zion (IL)

(21) Appl. No.: 18/475,780

(22) Filed: Sep. 27, 2023

(51) Int. Cl. G06F 16/22

(52) U.S. Cl. CPC G06F 16/2246; G06N 7/01

(57) ABSTRACT

A method for probability tree reduction includes receiving a probability tree structure with a plurality of nodes. At least one node structural value is associated with each of the plurality of nodes and quantifies an entropy of a subtree extending from a corresponding one of the plurality of nodes. The method further includes receiving at least one parameter for removing one or more nodes of the probability tree structure, removing at least one node of the plurality of nodes from the probability tree structure according to the parameter, calculating an updated entropy for each of the plurality of nodes upstream from the removed node, and outputting a reduced probability tree structure without the removed node and with the updated entropy for each of the plurality of nodes upstream from the removed node. Other example methods and systems for probability tree reduction are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to methods and systems for probability tree reduction.

Artificial Intelligence (AI) can be used in a fully autonomous or semi-autonomous vehicle to determine an action for the vehicle to take. For example, AI algorithms may be applied to compute and determine driving behaviors for such vehicles. In such examples, graphical models, such as probability trees, are often used for automated decision making. Probability trees (e.g., rooted graphs with probabilities on each vertex) are common data structures used in many automated systems (e.g., systems or machines making automated decisions such as automated vehicles). An example of such a tree is a Monte Carlo Tree Search (MCTS) that generates a probability tree structure as the output for sequential decision making. To reach a decision, the algorithm builds the probability tree data structure with the root node being the current state and each vertex being a different action that can be taken from the root node.

### SUMMARY

A method for probability tree reduction is disclosed. The method includes receiving a probability tree structure with a plurality of nodes. At least one node structural value is associated with each of the plurality of nodes, and the at least one node structural value quantifies an entropy of a subtree extending from a corresponding one of the plurality of nodes. The method further includes receiving at least one parameter for removing one or more nodes of the probability tree structure, removing at least one node of the plurality of nodes from the probability tree structure according to the parameter, calculating an updated entropy for each of the plurality of nodes upstream from the removed node, and outputting a reduced probability tree structure without the removed node and with the updated entropy for each of the plurality of nodes upstream from the removed node.

In other features, calculating the updated entropy for each of the plurality of nodes upstream from the removed node includes updating a visit count for each of the plurality of nodes upstream from the removed node.

In other features, removing the at least one node of the plurality of nodes from the probability tree structure includes removing the at least one node and an entire subtree of the probability tree structure downstream of the at least one node.

In other features, receiving at least one parameter for removing one or more nodes of the probability tree structure includes receiving at least one defined node to remove from the probability tree structure.

In other features, receiving at least one parameter for removing one or more nodes of the probability tree structure includes receiving at least one removal criterion for removing one or more nodes from the probability tree structure.

In other features, the at least one removal criterion includes at least one of a removal of all single child nodes, a removal of each parent node having less than a defined number of child nodes, and a removal of each node having less than a defined number of branches extending therefrom.

In other features, one of the plurality of nodes is a parent node with a plurality of child nodes downstream of the parent node.

In other features, the method further includes determining an optimal set of the plurality of child nodes to remove based on the at least one removal criterion.

In other features, removing the at least one node of the plurality of nodes from the probability tree structure includes removing the optimal set of the plurality of child nodes from the probability tree structure.

In other features, the optimal set of the plurality of child nodes includes one or more child nodes downstream of the parent node.

In other features, determining the optimal set of the plurality of child nodes to remove includes for each possible set of the plurality of child nodes for removal, calculating an updated entropy for each of the plurality of nodes upstream from the possible set assuming that the possible set is removed and calculating a tradeoff score based on the updated entropy and a size of the probability tree structure assuming that the possible set is removed.

In other features, determining the optimal set of the plurality of child nodes to remove includes selecting the possible set of the plurality of child nodes for removal having a highest value of the tradeoff score as the optimal set of the plurality of child nodes to remove.

In other features, the method further includes generating a list including a plurality of possible sets of one or more child nodes for removal based on the at least one removal criterion. Each possible set has a tradeoff score based on an updated entropy for each of the plurality of nodes upstream from the possible set assuming that the possible set is removed and a size of the probability tree structure assuming that the possible set is removed.

In other features, generating the list includes adding a possible set of one or more child nodes for removal to the list only if the tradeoff score for the possible set is greater than a reference value.

In other features, generating the list includes adding a possible set of one or more child nodes for removal to the list only if the tradeoff score for the possible set is greater than a tradeoff score for a parent node associated with the one or more child nodes.

In other features, generating the list includes prioritizing the plurality of possible sets of one or more child nodes in a descending order based on their tradeoff scores.

In other features, removing the at least one node of the plurality of nodes from the probability tree structure includes selecting the possible set of one or more child nodes from the prioritized list having a highest value of the tradeoff score and removing the selected set of one or more child nodes from the probability tree structure.

In other features, the method further includes updating the tradeoff score for each possible set after the selected set of one or more child nodes is removed from the probability tree structure.

In other features, the method further includes storing the reduced probability tree structure in a memory circuit.

An automated system includes a control module configured to receive a probability tree structure with a plurality of nodes. At least one node structural value is associated with each of the plurality of nodes, and the at least one node structural value quantifies an entropy of a subtree extending from a corresponding one of the plurality of nodes. The control module is further configured to receive at least one parameter for removing one or more nodes of the probability tree structure, remove at least one node of the plurality of nodes from the probability tree structure according to the parameter, calculate an updated entropy for each of the plurality of nodes upstream from the removed node, and output a reduced probability tree structure without the removed node and with the updated entropy for each of the plurality of nodes upstream from the removed node.

In other features, the automated system further includes a memory circuit in communication with the control module. The control module is configured to store the reduced probability tree structure in the memory circuit.

In other features, the at least one parameter is at least one removal criterion, one of the plurality of nodes is a parent node with a plurality of child nodes downstream of the parent node, and the control module is configured to determine an optimal set of the plurality of child nodes to remove based on the at least one removal criterion and remove the optimal set of the plurality of child nodes from the probability tree structure.

In other features, the at least one parameter is at least one removal criterion, and the control module is configured to generate a list including a plurality of possible sets of one or more child nodes for removal based on the at least one removal criterion. Each possible set has a tradeoff score based on an updated entropy for each of the plurality of nodes upstream from the possible set assuming that the possible set is removed and a size of the probability tree structure assuming that the possible set is removed.

In other features, the control module is configured prioritize the plurality of possible sets of one or more child nodes in a descending order based on their tradeoff scores and remove the possible set of one or more child nodes from the list having a highest value of the tradeoff score.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example system for probability tree reduction according to the present disclosure;

FIG. 2 is an example probability tree structure in a non-reduced state according to the present disclosure;

FIG. 3 is an example probability tree structure in a reduced state according to the present disclosure;

FIG. 4 is an example probability tree structure showing a generalized occurrence of a parent node and four child nodes downstream of the parent node, according to the present disclosure;

FIG. 5 is the probability tree structure of FIG. 4 but with two of the four child nodes identified for removal, according to the present disclosure;

FIG. 6 is an example probability tree structure with multiple nodes according to the present disclosure;

FIG. 7 is an autonomous vehicle including portions of the system of FIG. 1, according to the present disclosure; and

FIGS. 8-10 are flowcharts of example control processes for probability tree reduction, according to the present disclosure.

In the drawings, reference numbers may be reused to identify similar and/or identical elements.

### DETAILED DESCRIPTION

AI algorithms are applied to compute and determine automated decisions, such as driving behaviors for semi-autonomous and fully autonomous vehicles. In such examples, probability trees are often used for such features. For example, probability trees (e.g., MCTS, etc.) generate probability tree structures as an output for sequential decision making. However, in many scenarios, when applying sequential decision-making AI algorithms to real problems (e.g., autonomous driving, etc.), these probability trees can become very big and very complex. As one example, a MCTS may contain much of the logic used in choosing automated actions. For practical reasons, in many cases, it is desirable to better understand these trees, store them for debugging, compare or apply explainability (XAI) algorithms on them, etc. Such actions are costly in space (e.g., memory, etc.) and in computations (e.g., processing, etc.) due to the size and complexity of probability tree structures. Thus, wisely reducing the size of probability trees becomes a meaningful step so that the probability trees are decreased in size while preserving desirable logic.

The systems and methods according to the present disclosure enable the reduction of probability trees through the selective removal of nodes and their subtrees from the trees. In such examples, the selective removal of nodes and their subtrees are based on different received parameters, such as reduction-criteria as further explained below. In this manner, and as further explained below, a tradeoff may be achieved to ensure a desirable reduction in size of a probability tree (e.g., reducing the size of the probability tree as much as possible) while minimizing a change in its original entropy of the tree. As such, with this tradeoff, the probability tree may be significantly reduced in size while preserving the interest in the tree structure.

For example, the reduction-criteria may take into consideration the tradeoff between the size of the tree (e.g., a number of nodes) and the information/interest in the tree. With such examples, it may be desirable to preserve wider subtrees of the tree as they generally contain more information, as opposed to subtrees that are thin (e.g., closer to branch subtrees) and generally contain little information. In this manner, the probability tree may be significantly reduced in size while preserving desirable information.

Numerous benefits result from the reduction in probability tree size. For example, the amount of memory required to store probability tree structures is decreased with the reduced probability tree size as compared to conventional systems. Additionally, the amount of processing requirements (e.g., power, computations, etc.) for processing the probability tree structures is decreased with the reduced probability tree size as compared to conventional systems. Further, transmission requirements for transmitting the probability tree structures are decreased with the reduced probability tree size as compared to conventional systems.

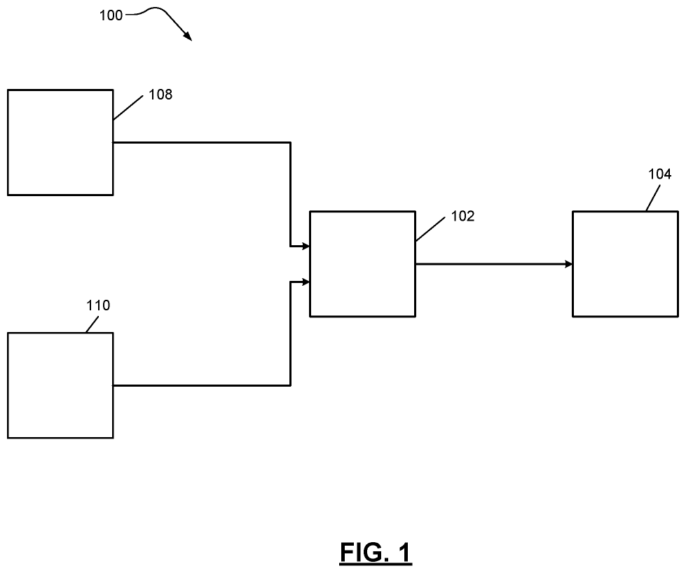

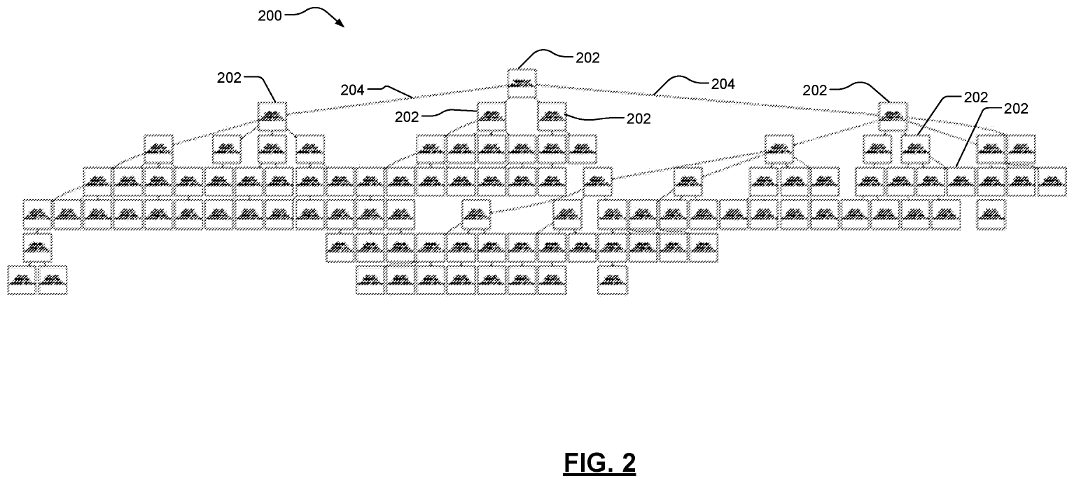

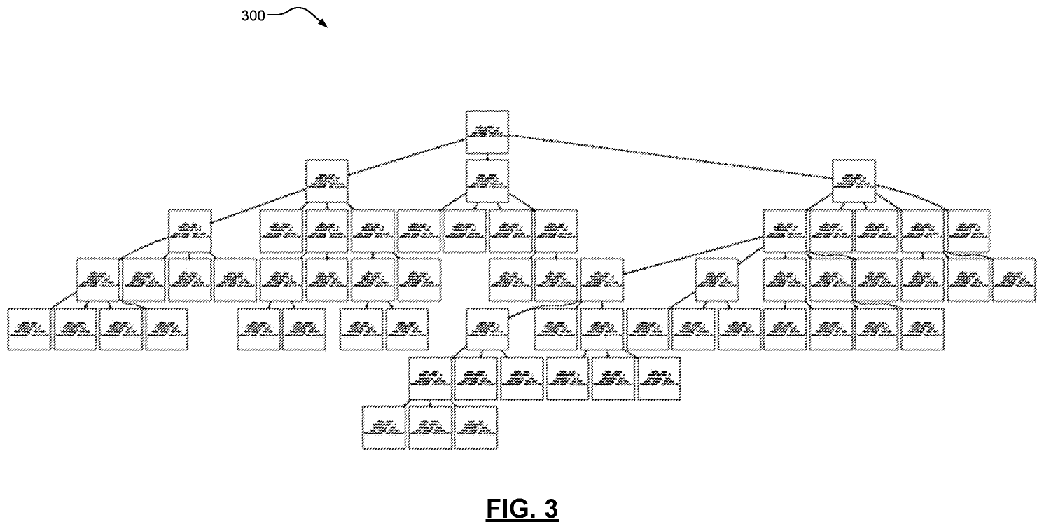

Referring now to FIG. 1, a block diagram of an example system 100 is presented for probability tree reduction. For example, the system 100 of FIG. 1 is configured to reduce a probability tree such as a probability tree structure 200 of FIG. 2 into a reduced probability tree such as a probability tree structure 300 of FIG. 3. In other words, the probability tree structure 300 is a reduced version of the probability tree structure 200 of FIG. 2.

The system 100 of FIG. 1 may be employable in any suitable vehicle, such as an electric vehicle (e.g., a pure electric vehicle, a plug-in hybrid electric vehicle, etc.), an internal combustion engine vehicle, etc. Additionally, the system 100 may be applicable to autonomous vehicles, such as semi-autonomous vehicles and fully autonomous vehicles. While the system 100 of FIG. 1 and/or other systems and methods herein are described with respect to probability tree reduction with vehicle implementations, it should be appreciated that any one of the systems and/or methods herein may be applicable for non-vehicle implementations if desired.

As shown in FIG. 1, the system 100 generally includes a control module 102, a memory circuit 104, a probability tree module 108, and parameter module 110. In such examples, the control module 102 may be in communication with each of the other components as shown in FIG. 1. Although FIG. 1 illustrates the system 100 as including specific modules, it should be appreciated that one or more other modules may be employed if desired. Additionally, while the system 100 is shown as including multiple separate modules (e.g., the control module 102, the probability tree module 108, etc.), any combination of the modules and/or the functionality thereof may be integrated into one or more modules.

In the example of FIG. 1, the probability tree module 108 and the parameter module 110 may provide inputs to the control module 102. For example, the probability tree module 108 may store, generate and/or receive one or more probability tree structures each with multiple nodes for automated decision-making processes. Additionally, the parameter module 110 may store and/or receive parameters for removing one or more nodes of the probability tree structure of the probability tree module 108. In such examples, the control module 102 receives at least one of the probability tree structures and one or more parameters for removing nodes of the received probability tree structure, as further explained below. For example, the probability tree structure 200 of FIG. 2 may be provided by the probability tree module 108 to the control module 102.

In various embodiments, the probability tree module 108 and/or the parameter module 110 of FIG. 1 may include a storage structure (e.g., a database, a memory circuit, etc.) for storing probability tree structures and/or parameters. In such examples, the probability tree module 108 and/or the parameter module 110 may receive inputs (e.g., user inputs, etc.) defining the parameters, the probability tree structures, etc. In other examples, the parameter module 110 may calculate or otherwise determine parameters if desired.

The memory circuit 104 may be any suitable storage component as explained here. In such examples, the memory circuit 104 receives a reduced probability tree structure from the control module 102 and stores the reduced probability tree structure for later implementation if desired. For example, the probability tree structure 300 of FIG. 3 is a reduced version of the probability tree structure 200 of FIG. 2 and is generated by the control module 102 and stored in the memory circuit 104.

In the example of FIG. 1, the probability tree module 108 may generate the probability tree structure based on one or more sensors. For example, the probability tree module 108 may be or associated with an autonomous control module that generates the probability tree structure. In such examples, the probability tree module 108 may generate the tree structure in a decision-making process for an autonomous vehicle based on feedback from the one or more sensors for obtaining information about the surroundings or environment of, for example, an autonomous vehicle, etc. In such examples, the one or more sensors may include, for example, cameras, lidar, radar, GPS, etc.

In various embodiments, the probability tree structures herein may be any suitable data structure used in automated systems. For example, the probability tree structure 200 of FIG. 2 is one suitable example. As shown, the probability tree structure 200 includes multiple nodes 202 and an edge 204 connecting any two of the nodes 202. Each node 202 represents a state of a system (e.g., an autonomous vehicle), and each edge 204 represents an action that takes the system from one state to another state (a subsequent state or future state). A root node (e.g., the top node) of the probability tree structure 200 represents a current state of the system. Subsequent possible states are shown below the top node. Each action or edge has an associated probability.

A sequence of actions through the probability tree structure 200 is referred to as a trajectory. In such examples, a control module (e.g., the probability tree module 108 of FIG. 1.) starts at the root node (e.g., the current state of the system). The control module then selects an action to take in the probability tree as evaluated from the root node. Once the action is executed, the system moves to a resulting state. The control module identifies the resulting state as a new root node and a new tree is expanded so that the optimization algorithm can be performed from the new root node.

In various embodiments, analysis of a probability tree structure (e.g., the probability tree structure 200 of FIG. 2) may provide a node structural value that describes a structure of branches, or a subtree, spanning from a given node in the probability tree. Instead of going down the probability tree structure 200, the node structural value indicates the probability tree structure 200 spanning from each of the nodes. Larger node structural values reflect more uncertainty in the probability tree. This corresponds to wider trees (e.g., more branches in the different layers of the subtree). The node structural values can be normalized to reflect the uncertainty per-node, so that a smaller subtree can be compared with a larger subtree.

Each node structural value provides an entropy value for a given node to describe a structure (e.g., branches or a subtree) of the probability tree spanning from that node. For example, if a node does not include branches or a subtree, the node structural value for that node may be zero. Further information and examples regarding determining (e.g., calculating, etc.) the node structural value or entropy of a given node may be found in commonly assigned U.S. application Ser. No. 18/336,115 filed on Jun. 16, 2023, which is incorporated herein in its entirety.

In the examples herein, a reduced version of a given tree data structure such as the probability tree structure 200 of FIG. 2 may be computed based on various parameters. For example, the control module 102 of FIG. 1 may implement one or more procedures (e.g., a greedy reduction procedure down the tree, a two-stage greedy reduction, etc.) for removing subtrees from the probability tree data structure, as further explained below. In such examples, the reduction of the tree data structure may be based on reduction criteria, as further explained below. In various embodiments, the control module 102 may rely on a trade-off between the entropy and the size of the tree data structure when removing subtrees from the tree data structure.

For example, in some cases it may be desirable to reduce the size of the probability tree structure as much as possible while reducing its original entropy as little as necessary. To do so, a trade-off score based on the reduced size and the entropy may be maximized. For instance, a trade-off score may be maximized according to equation (1) below. In equation (1), the H(T) refers to the entropy (e.g., as explained in U.S. application Ser. No. 18/336,115 referenced above), S is the size of the probability tree structure (e.g., the number of nodes, number of visits, etc.), A is the number of possible children a node may have, and β is a trade-off parameter. In such examples, it is desirable to reduce a value of the size S as much as possible but with as little reduction to a value of the entropy H(T).

$$max \{ H ( {T}^{0} ) - β * log ( \vert A \vert ) * S \} \qquad ( 1 )$$

In the example above, the trade-off parameter β may be limited. For example, since for any value of the trade-off parameter β it is possible to obtain zero by an empty tree, the trade-off parameter β may be limited to positive values. As such, with this limitation, the trade-off parameter β may be limited between a value greater than zero and upper bound limit. For example, equation (2) below shows the limits of the trade-off parameter β based on equation (1) above. In this example, Bub represents an upper bound of the trade-off parameter β.

$$β \leq \frac{H ( {T}^{0} )}{log ( \vert A \vert ) * S} ≡ {β}_{ub} \qquad ( 2 )$$

In various embodiments, the removal of nodes and their subtrees from a probability tree structure may be based on defined nodes. For example, the control module 102 may receive a probability tree structure (e.g., the probability tree structure 200 of FIG. 2) from the probability tree module 108 and a parameter from the parameter module 110 representing one or more defined nodes to remove from the probability tree structure. In such examples, the control module 102 may then remove the defined node(s) and the entire subtree downstream from the node(s).

Once removed, the control module 102 may then calculate updated values of various data. For example, the control module 102 may update data associated with the size of the reduced probability tree structure, such as a number of visits count, a number of nodes, etc. Additionally, the control module 102 may calculate an updated entropy for each of the remaining nodes upstream from the removed nodes (e.g., as explained in U.S. application Ser. No. 18/336,115 referenced above).

Then, the control module 102 may output the reduced probability tree structure (e.g., the reduced probability tree structure 300 of FIG. 3) without the removed nodes and with the updated entropy for each node upstream from the removed nodes. In such examples, the reduced probability tree structure may be provided to the memory circuit 104 as explained above.

In other embodiments, the removal of nodes and their subtrees from a probability tree structure may be based on at least one removal criterion for removing one or more nodes from the probability tree structure. In such examples, the control module 102 may receive the removal criterion (e.g., a parameter) from the parameter module 110 as explained herein. The removal criterion may be any suitable criterion for node removal, such as the removal of all single child nodes, the removal of each parent node having less than a defined number of child nodes, the removal of each node having less than a defined number of branches extending therefrom, etc.

One example procedure for removing nodes and their subtrees from a probability tree structure based on removal criterion is a greedy reduction procedure down the tree. In this procedure, the control module 102 may receive a probability tree structure (e.g., the probability tree structure 200 of FIG. 2) from the probability tree module 108 and at least one removal criterion from the parameter module 110, as explained above.

The control module 102 may then determine an optimal set of nodes for removal from the probability tree structure based on the removal criterion. For example, FIG. 4 depicts an example probability tree structure 400 showing a generalized occurrence of a parent node and children nodes, which may generally repeat multiple times in the tree. Specifically, the probability tree structure 400 is shown as including nodes 402, 404, 406, 408, 410, with the node 402 representing a parent node and the nodes 404, 406, 408, 410 representing child nodes downstream of the parent node 402. In such examples, the control module 102 determines an optimal set of child nodes 404, 406, 408, 410 to remove based on the removal criterion.

This determination of the optimal set may be based on tradeoff scores for different removal options. For example, given the parent node 402, the set of possible reductions is all subsets of the child nodes 404, 406, 408, 410 (of the current parent node 402). For instance, the possible reductions may include any combination of nodes to remove, such as no nodes (e.g., keep all of the child nodes 404, 406, 408, 410), remove the child node 404 (e.g., keep the child nodes 406, 408, 410), remove the child node 406 (e.g., keep the child nodes 404, 408, 410), remove the child node 408 (e.g., keep the child nodes 404, 406, 410), remove the child node 410 (e.g., keep the child nodes 404, 406, 408), remove the child nodes 404, 406 (e.g., keep the child nodes 408, 410), remove the child nodes 404, 408 (e.g., keep the child nodes 406, 410), and so forth. In such examples, the child nodes to keep may be refereed to childrenToKeep.

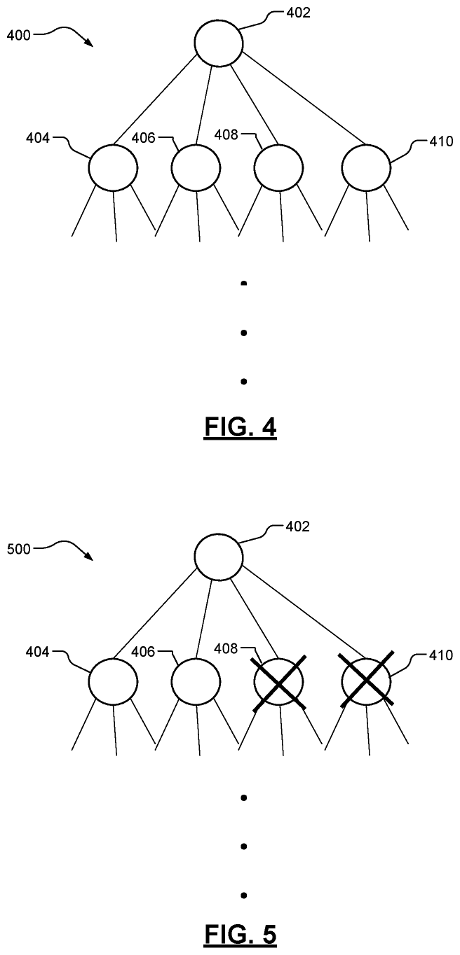

Then, for each possible set of child nodes 404, 406, 408, 410 for removal, the control module 102 may recursively go up the tree and evaluate various data values. For example, the nodes to remove may be the possible set of the child nodes 408, 410 and the nodes to keep (childrenToKeep) may be the child nodes 404, 406. FIG. 5 depicts an example probability tree structure 500 showing the generalized occurrence of the nodes 402, 404, 406 of FIG. 4, and with the child nodes 408, 410 removed. In this example, the number of visit counts for the child nodes 408, 410 are set to zero (0). Then, the control module 102 calculates an updated entropy for each node (e.g., the parent node 402) upstream from the possible set assuming that the child nodes 408, 410 are removed and calculates a tradeoff score (e.g., as explained above) based on the updated entropy and a size of the probability tree structure assuming that the child nodes 408, 410 are removed.

The control module 102 recursively performs such calculations for each possible set of reductions. Once completed, the control module 102 selects the optimal set for removal. For example, the control module 102 may select the possible set of child nodes 404, 406, 408, 410 for removal having a highest value of the tradeoff score (over the entire tree) from the possible removals at the parent node 402 as the optimal set to remove. With such configurations, the control module 102 is able to identify local independent removals for a set of a parent node and its child nodes.

The control module 102 may then remove the optimal set of nodes from the probability tree structure and any subtree of the nodes. Once the nodes are actually removed, the control module 102 may then calculate updated values of various data, as explained herein. Then, the control module 102 may output the reduced probability tree structure (e.g., the reduced probability tree structure 300 of FIG. 3) without the removed nodes, as explained herein.

Alternatively, the control module 102 may examine removals at the remaining children (the childrenToKeep), and repeat the process described above. For instance, the greedy reduction procedure may continue down the tree with control module 102 performing the process described above over the nodes that were not removed. For example and with reference to FIG. 5, the control module 102 may perform the process described above over the nodes 404, 406 that were not removed.

Another example procedure for removing nodes and their subtrees from a probability tree structure based on removal criterion is a two-stage greedy reduction. In the two-stage greedy reduction procedure, the control module 102 may receive a probability tree structure (e.g., the probability tree structure 200 of FIG. 2) from the probability tree module 108 and at least one removal criterion from the parameter module 110, as explained above.

The two-stage greedy reduction procedure generally includes two phases. The first phase includes moving down the probability tree structure and generating a list (e.g., a priority list pList) of possible removals. For example, after receiving the probability tree structure and the removal criterion, the control module 102 may determine (e.g., create) the list including possible (e.g., suggested) sets of one or more nodes for removal based on the removal criterion. In such examples, each possible set has a tradeoff score or value (e.g., as calculated by the control module 102 as explained above) based on an updated entropy for each of the nodes upstream from the possible set assuming that the possible set is removed and a size of the probability tree structure assuming that the possible set is removed. For example, for each suggested removal, the control module 102 may calculate the tradeoff score of a suggested removal by going up the tree and adding each tree size reduction determination step (e.g., β*log(|A|)*S). This results in a global set of removals to reduce the tree instead of local independent removals.

In some examples, the control module 102 may add a possible set of one or more nodes for removal to the list only if certain conditions apply. For example, the control module 102 may add a possible set of nodes for removal only if the tradeoff score for the possible set is greater than a reference value. In such examples, the reference value may be user defined, calculated by the control module 102, etc. For instance, the control module 102 may calculate the reference value based on the specific removal criterion used and/or another received input. In other examples, the control module 102 may calculate the reference value based on the entropy-size trade-off for a given value of the trade-off parameter β.

Additionally and/or alternatively, the control module 102 may add a possible set of nodes for removal only if the tradeoff score for the possible set is greater than a tradeoff score for a parent node associated with the one or more nodes. As such, to be included on the list, the suggested removal must be better than the suggested removals of its ancestors (e.g., those that removed the current node).

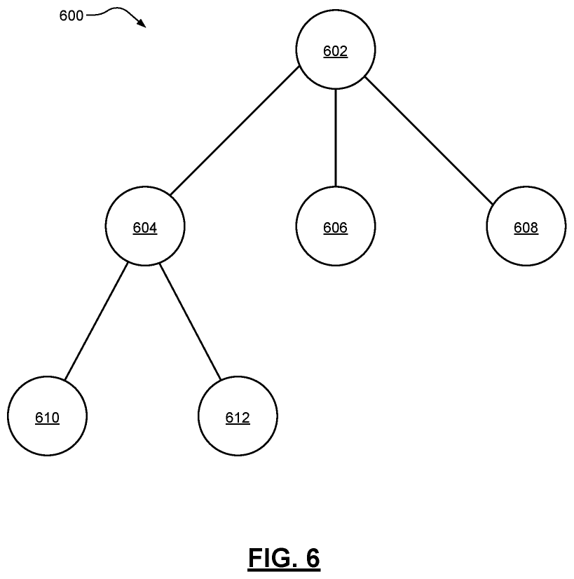

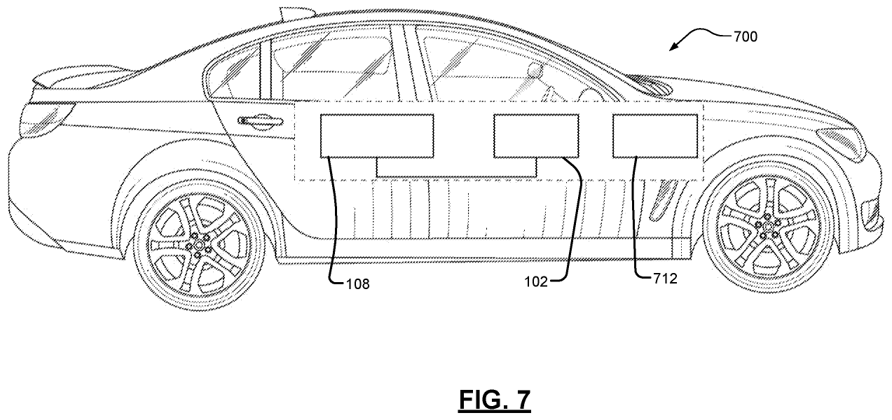

For example, FIG. 6 depicts a simplified probability tree structure 600 including nodes 602, 604, 606, 608, 610, 612. As shown, the nodes 602, 604 represent parent nodes and the nodes 604, 606, 608, 610, 612 represent child nodes. In this example, the control module 102 may suggest removal of nodes as explained above. For example, at node 602, the control module 102 may suggest to remove the node 604 and keep the nodes 606, 608 all of which are children of the node 602. In this example, the node 602 is an ancestor of the node 604 because the node 602 suggested to remove it. Additionally, at node 604, the control module 102 may suggest to remove the node 610 and keep the node 612. In this example, the node 604 is an ancestor of the node 610 since the node 604 suggested to remove it. However, the node 602 is not an ancestor of the node 612 since the node 604 suggested to keep it. In such examples, the suggested removal must be better than the suggested removals of its ancestors to be included on the list.

In various embodiments, the list of the possible sets of nodes may be prioritized as desired. For example, the control module 102 may prioritize the possible sets of nodes on the list in a descending order based on their tradeoff scores. In other words, the control module 102 may prioritize the list of the suggested removals from high to low. In such examples, the list is ordered with the suggested removals shown to be more beneficial on top and above the suggested removals shown to be less beneficial. In other examples, the list of the possible sets of nodes for removal may be prioritized, ordered, etc. in another suitable manner (or not prioritized, ordered, etc.).

In some examples, the list of the possible sets of nodes for removal may overlap. For example, the list may contain a current suggestion to remove a node that had an ancestor. In other words, a parent node already suggested to remove a subtree containing the current suggestion. Such scenarios can be handled in various manners. One option may be to update the values of the ancestor parents according to the advantage that they provide (by their suggested removal) after, or with respect to, the currently suggested removal. In other words, the removals in the ancestors are measured given that the current removal has been performed. By doing this, the priority list better reflects the advantage of the removal of the ancestor, which comes only after the removal done in the current node. In other examples, all possible removals from the ancestor may be considered (e.g., by recalculating the best removal option) given that the current suggested removal has already been performed.

Then, once the list of suggested sets is completed, the control module 102 may begin removing sets of nodes from the probability tree structure. This may be referred to as the second phase of the two-stage greedy reduction procedure. For example, the control module 102 may traverse the generated list and apply the suggested removals (one after the other) and update the probability tree structure after each removal.

For instance, the control module 102 may select the possible set (e.g., the suggested set) of nodes from the prioritized list having a highest value of the tradeoff score (e.g., the suggested set at the top of the list), and then remove that selected set from the probability tree structure. Once removed, the control module 102 may calculate updated values of various data (e.g., the tradeoff score, the entropy, the number of visits, the size, etc.), as explained herein.

In various embodiments, the control module 102 may optionally reprioritize the possible sets of nodes for removal in the descending order based on the updated tradeoff scores if desired. In such examples, the control module 102 may reevaluate the suggested removals in the priority list before such reprioritization is implemented. With such a configuration, the amount of computations to reprioritize the possible sets of nodes for removal may be significant.

The control module 102 may then select the next possible (or suggested) set of nodes from the prioritized (or the reprioritized) list for removal and again calculate updated values of various data. This may continue as desired. For example, the selection and removal of nodes may continue until a defined condition applies. For instance, the procedure may continue until the probability tree structure is left with a defined number of nodes, a defined value, a defined trade-off, a defined entropy, etc. Then, once the removal of suggested sets of nodes is completed, the control module 102 may output the reduced probability tree structure (e.g., the reduced probability tree structure 300 of FIG. 3) without the removed nodes, as explained herein.

As explained above, the system 100 and/or other similar automated systems may be employable in any suitable autonomous vehicle. For example, FIG. 7 depicts a vehicle 700 that can be operated in an autonomous mode or automated mode according to the system 100 of FIG. 1. For instance, the vehicle 700 includes the control module 102, the probability tree module 108 and the probability tree module 108 of FIG. 1, and one or more sensors 712 usable in an automated decision-making process for the vehicle 700. In such examples, the control module 102 may reduce the size of a probability tree structure as explained herein.

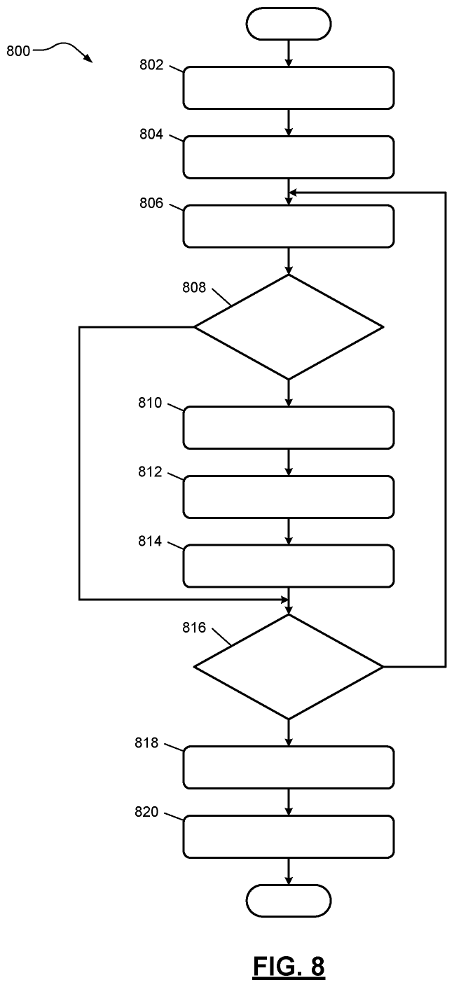

FIGS. 8-10 illustrate example control processes 800, 900, 1000 employable by the system 100 of FIG. 1 for probability tree reduction. Although the example control processes 800, 900, 1000 are described in relation to the system of FIG. 1 including the control module 102, any one of the control processes 800, 900, 1000 may be employable by any suitable system.

In FIG. 8, the control process 800 begins at 802, where the control module 102 receives a probability tree structure. In such examples, the probability tree structure may be received from the probability tree module 108 of FIG. 1 or another suitable source, as explained above. Control then proceeds to 804, where the control module 102 receives one or more defined nodes for removal from the probability tree structure. The defined nodes may be provided by the parameter module 110 of FIG. 1 or another suitable source, as explained above. Control then proceeds to 806, where the control module 102 selects one of the defined nodes for removal. Control then proceeds to 808.

At 808, the control module 102 determines whether the selected node has a parent node. If the selected node does not have a parent node (e.g., the selected node is a root node), control proceeds to 816. If, however, the selected node does have a parent node (e.g., the selected node is not a root node), control proceeds to 810.

At 810, the control module 102 removes the selected node and the entire subtree downstream of the selected node. Control then proceeds to 812, 814. The control module 102 updates the number of visits count (e.g., a size of the tree) at 812 and updates the entropy at 814, as explained herein. Control then proceeds to 816.

At 816, the control module 102 determines whether any more defined nodes for removal are present. If yes, control returns to 806. Otherwise, control proceeds to 818, where the control module 102 outputs the reduced probability tree structure. For example, the control module 102 may output the reduced probability tree structure to the memory circuit 104 of FIG. 1. Then, at 820, control may store the reduced probability tree structure in the memory circuit 104 as explained herein.

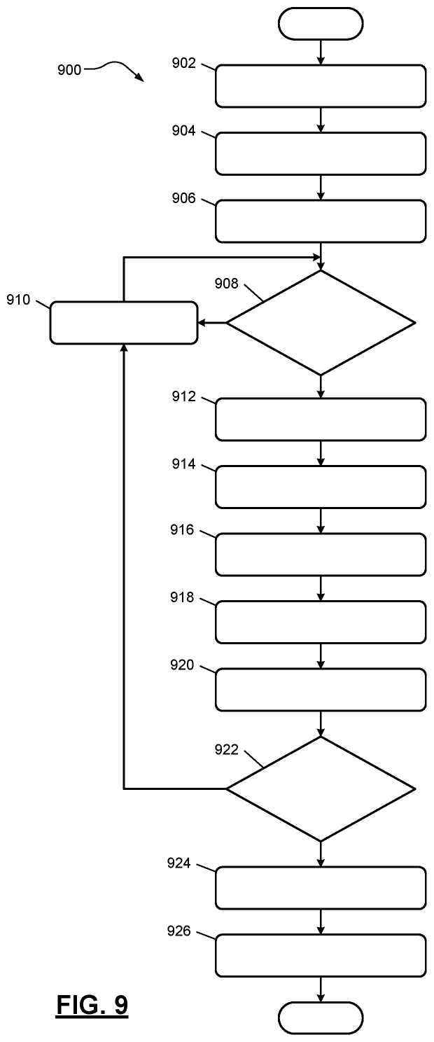

In FIG. 9, the control process 900 begins at 902, where the control module 102 receives a probability tree structure from, for example, the probability tree module 108 of FIG. 1 or another suitable source, as explained above. Control then proceeds to 904, where the control module 102 receives one or more removal criterion. In such examples, the removal criterion may be provided by the parameter module 110 of FIG. 1 or another suitable source, as explained above. Control then proceeds to 906, where the control module 102 selects a node (e.g., a root node) of the probability tree structure. Control then proceeds to 908.

At 908, the control module 102 determines whether the selected node has any child node. If no, control proceeds to 910 where the control module 102 selects another node (e.g., the next node) of the probability tree structure. Control then returns to 908. If, however, the selected node has a child node, control proceeds to 912.

At 912, the control module 102 evaluates each set of child nodes of all possible sets from the selected node. For example, and as explained above, the control module 102 may recursively go up the tree and evaluate various data values for each possible set of child nodes for removal. In such examples, the evaluated values may include, for example, an evaluated entropy for each node upstream from the possible set, an evaluated size, an evaluated tradeoff score, etc. Control proceeds to 914.

At 914, the control module 102 selects an optimal set of child nodes for removal based on the evaluation of all possible sets. In such examples, the control module 102 may select the set of child nodes having the highest tradeoff score as the optimal set for removal. Control proceeds to 916, where the control module 102 removes the optimal set and the entire subtree(s) downstream of the optimal set.

Then, the control module 102 calculates an updated entropy for each node (e.g., the parent node 402) upstream from the possible set assuming that the child nodes 408, 410 are removed and calculates a tradeoff score (e.g., as explained above) based on the updated entropy and a size of the probability tree structure assuming that the child nodes 408, 410 are removed. Control then proceeds to 918, 920.

At 918, the control module 102 updates the number of visits count (e.g., a size of the tree), as explained above. At 920, the control module 102 updates the entropy, as explained herein. Control then proceeds to 922.

At 922, the control module 102 determines whether any more nodes are present. In other words, the control module 102 may determine whether control has reached an end state of a trajectory in the probability tree structure (e.g., a leaf node equals a node with no children). If more nodes are present, control returns to 910. Otherwise, control proceeds to 924, where the control module 102 outputs the reduced probability tree structure as explained above. Then, control proceeds to 926, where control may store the reduced probability tree structure in the memory circuit 104 as explained herein.

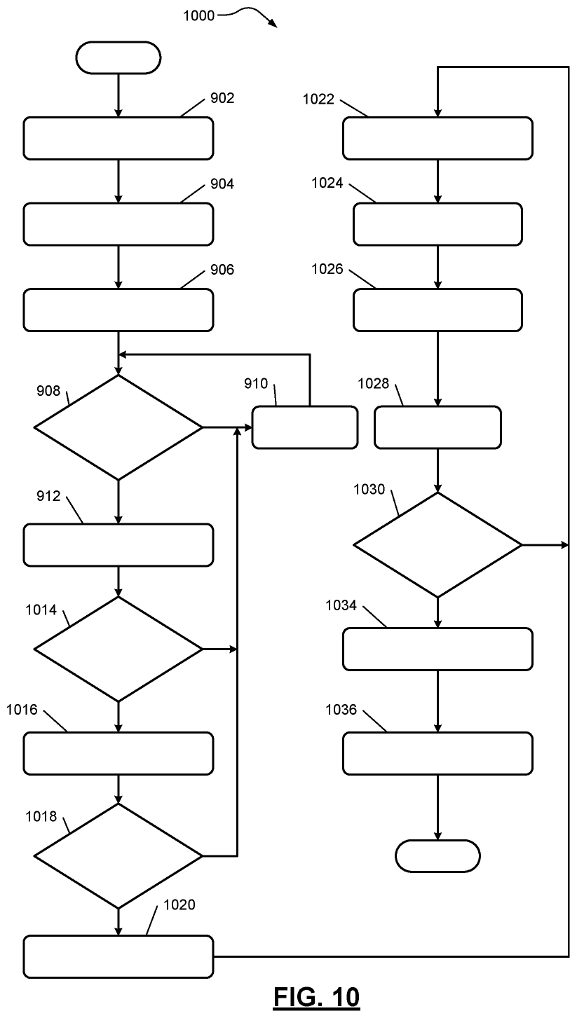

In FIG. 10, the control process 1000 is similar to the control process 900 of FIG. 9, but with additional and/or alternative control features. For example, the control process 1000 of FIG. 10 includes the steps 902, 904, 906, 908, 910, 912 as explained above relative to the control process 900 of FIG. 9. In such examples, if the control module 102 determines the selected node has no child node at 908, control proceeds to 910. Otherwise, if the control module 102 determines the selected node has a child node at 908, control proceeds to 912 where control evaluates each set of child nodes of all possible sets from the selected node as explained above. Control then proceeds to 1014.

At 1014, the control module 102 determines whether to add an evaluated set of nodes (e.g., one node, two nodes, etc.) to a priority list. For example, in some embodiments, the evaluated set may be added to the priority list only if an updated data value (e.g., a tradeoff score) for the set of nodes for removal is greater than a reference value and/or greater than a tradeoff score for a parent node associated with the one or more nodes in the evaluated set, as explained herein. If the control module 102 determines that the evaluated set should not be added to the priority list, control returns to 910 where the control module 102 selects another node (e.g., the next node). Otherwise, if the control module 102 determines that the evaluated set should be added to the priority list, control proceeds to 1016 where the control module 102 adds the evaluated set to the list as a suggested set for removal. Control then proceeds to 1018.

At 1018, the control module 102 determines whether any more nodes are present as explained above. If yes, control returns to 910. If no, control proceeds to 1020 where the control module 102 prioritizes the suggested sets of nodes on the list. For example, the control module 102 may prioritize the suggested sets for removal in a descending order based on their tradeoff scores, as explained above. Control then proceeds to 1022.

At 1022, the control module 102 selects one of the suggested sets of nodes for removal. For example, the control module 102 may select the suggested set that is highest (e.g., first) on the ordered priority list or another suitable suggested set. Control then proceeds to 1024 where the control module 102 removes the selected suggested set and the entire subtree(s) downstream of that set. Control then proceeds to 1026, 1028. The control module 102 updates the number of visits count (e.g., a size of the tree) at 1026 and updates the entropy at 1028, as explained herein. Control then proceeds to 1030.

At 1030, the control module 102 determines whether a condition is met to stop selecting and removing suggested sets from the priority list. For example, the selection and removal of nodes may continue until the probability tree structure is left with a predefined number of nodes, a predefined value, a predefined entropy, etc. as explained above. If no at 1030, control returns to 1022 where the control module 102 selects another one of the suggested sets of nodes for removal (e.g., the next suggested set of one of more nodes on the priority list). Otherwise, if yes at 1030 (e.g., a condition is met), control proceeds to 1034.

At 1034, the control module 102 outputs the reduced probability tree structure as explained above. Then, control proceeds to 1036, where control may store the reduced probability tree structure in the memory circuit 104 as explained herein.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for probability tree reduction, the method comprising:
receiving a probability tree structure with a plurality of nodes, wherein at least one node structural value is associated with each of the plurality of nodes, and the at least one node structural value quantifies an entropy of a subtree extending from a corresponding one of the plurality of nodes;
receiving at least one parameter for removing one or more nodes of the probability tree structure;
removing at least one node of the plurality of nodes from the probability tree structure according to the parameter;
calculating an updated entropy for each of the plurality of nodes upstream from the removed node; and
outputting a reduced probability tree structure without the removed node and with the updated entropy for each of the plurality of nodes upstream from the removed node.

2. The method of claim 1, wherein calculating the updated entropy for each of the plurality of nodes upstream from the removed node includes updating a visit count for each of the plurality of nodes upstream from the removed node.

3. The method of claim 1, wherein removing the at least one node of the plurality of nodes from the probability tree structure includes removing the at least one node and an entire subtree of the probability tree structure downstream of the at least one node.

4. The method of claim 1, wherein receiving at least one parameter for removing one or more nodes of the probability tree structure includes receiving at least one defined node to remove from the probability tree structure.

5. The method of claim 1, wherein receiving at least one parameter for removing one or more nodes of the probability tree structure includes receiving at least one removal criterion for removing one or more nodes from the probability tree structure.

6. The method of claim 5, wherein the at least one removal criterion includes at least one of a removal of all single child nodes, a removal of each parent node having less than a defined number of child nodes, and a removal of each node having less than a defined number of branches extending therefrom.

7. The method of claim 5, wherein:
one of the plurality of nodes is a parent node with a plurality of child nodes downstream of the parent node;
the method further comprises determining an optimal set of the plurality of child nodes to remove based on the at least one removal criterion; and
removing the at least one node of the plurality of nodes from the probability tree structure includes removing the optimal set of the plurality of child nodes from the probability tree structure.

8. The method of claim 7, wherein the optimal set of the plurality of child nodes includes one or more child nodes downstream of the parent node.

9. The method of claim 7, wherein determining the optimal set of the plurality of child nodes to remove includes:
for each possible set of the plurality of child nodes for removal, calculating an updated entropy for each of the plurality of nodes upstream from the possible set assuming that the possible set is removed and calculating a tradeoff score based on the updated entropy and a size of the probability tree structure assuming that the possible set is removed; and
selecting the possible set of the plurality of child nodes for removal having a highest value of the tradeoff score as the optimal set of the plurality of child nodes to remove.

10. The method of claim 5, further comprising generating a list including a plurality of possible sets of one or more child nodes for removal based on the at least one removal criterion, wherein each possible set has a tradeoff score based on an updated entropy for each of the plurality of nodes upstream from the possible set assuming that the possible set is removed and a size of the probability tree structure assuming that the possible set is removed.

11. The method of claim 10, wherein generating the list includes adding a possible set of one or more child nodes for removal to the list only if the tradeoff score for the possible set is greater than a reference value.

12. The method of claim 10, wherein generating the list includes adding a possible set of one or more child nodes for removal to the list only if the tradeoff score for the possible set is greater than a tradeoff score for a parent node associated with the one or more child nodes.

13. The method of claim 10, wherein generating the list includes prioritizing the plurality of possible sets of one or more child nodes in a descending order based on their tradeoff scores.

14. The method of claim 13, wherein removing the at least one node of the plurality of nodes from the probability tree structure includes selecting the possible set of one or more child nodes from the prioritized list having a highest value of the tradeoff score and removing the selected set of one or more child nodes from the probability tree structure.

15. The method of claim 14, further comprising updating the tradeoff score for each possible set after the selected set of one or more child nodes is removed from the probability tree structure.

16. The method of claim 1, further comprising storing the reduced probability tree structure in a memory circuit.

17. An automated system comprising:
a control module configured to:
receive a probability tree structure with a plurality of nodes, wherein at least one node structural value is associated with each of the plurality of nodes, and the at least one node structural value quantifies an entropy of a subtree extending from a corresponding one of the plurality of nodes;
receive at least one parameter for removing one or more nodes of the probability tree structure;
remove at least one node of the plurality of nodes from the probability tree structure according to the parameter;
calculate an updated entropy for each of the plurality of nodes upstream from the removed node; and
output a reduced probability tree structure without the removed node and with the updated entropy for each of the plurality of nodes upstream from the removed node.

18. The automated system of claim 17, further comprising a memory circuit in communication with the control module, wherein the control module is configured to store the reduced probability tree structure in the memory circuit.

19. The automated system of claim 17, wherein:
the at least one parameter is at least one removal criterion;
one of the plurality of nodes is a parent node with a plurality of child nodes downstream of the parent node; and
the control module is configured to determine an optimal set of the plurality of child nodes to remove based on the at least one removal criterion and remove the optimal set of the plurality of child nodes from the probability tree structure.

20. The automated system of claim 19, wherein:
the at least one parameter is at least one removal criterion; and
the control module is configured to:
generate a list including a plurality of possible sets of one or more child nodes for removal based on the at least one removal criterion, wherein each possible set has a tradeoff score based on an updated entropy for each of the plurality of nodes upstream from the possible set assuming that the possible set is removed and a size of the probability tree structure assuming that the possible set is removed;
prioritize the plurality of possible sets of one or more child nodes in a descending order based on their tradeoff scores; and
remove the possible set of one or more child nodes from the list having a highest value of the tradeoff score.
